(19) United States
(12) Patent Application Publication
(10) Pub. No.: US 2022/0083631 A1
(43) Pub. Date: Mar. 17, 2022

(54) SYSTEMS AND METHODS FOR FACILITATING ACCESS TO DISTRIBUTED RECONSTRUCTED 3D MAPS

(71) Applicant: Facebook Technologies, LLC, Menlo Park, CA (US)

(72) Inventors: Hao Chen, Kirkland, WA (US); Richard Andrew Newcombe, Seattle, WA (US)

(21) Appl. No.: 17/138,307

(22) Filed: Dec. 30, 2020

Related U.S. Application Data
(60) Provisional application No. 63/078,807, filed on Sep. 15, 2020.

(51) Int. Cl. G06F 21/31; G06F 16/93

(52) U.S. Cl. CPC G06F 21/31; G06F 16/93

(57) ABSTRACT

A method includes a computing system associated with an AR device querying, based on a location of the AR device, a registry associated with a distributed map network for a first gateway address associated with a first gateway that provides access to a 3D street map in a physical region. The system downloads the 3D street map by connecting to the first gateway using the first gateway address. The system predicts that the AR device will enter a building in the physical region and queries the registry for a second gateway address associated with a second gateway. The system requests, using the second gateway address, access to the second gateway by providing user authentication information. The system downloads a 3D interior map associated with the building through the second gateway and localizes the AR device within the building using the 3D interior map after the AR device enters the building.

### PRIORITY

This application claims the benefit under 35 U.S.C. § 119(e) of U.S. Provisional Patent Application No. 63/078,807, filed 15 Sep. 2020, which is incorporated herein by reference.

### TECHNICAL FIELD

This disclosure generally relates to facilitating and determining access to distributed reconstructed three-dimensional maps.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

A mobile computing device, such as a smartphone, tablet computer, or laptop computer, may include functionalities for determining its location, direction, or orientation, using motion sensors such as a GPS receiver, compass, gyroscope, or accelerometer. Such a device may also include functionalities for wireless communication including BLUETOOTH communication, near-field communication (NFC), or infrared (IR) communication, or communication with a wireless local area networks (WLANs) or cellular-telephone network. Such a device may also include one or more cameras, scanners, touchscreens, microphones, or speakers. Mobile computing devices may also execute software applications, such as games, web browsers, AR/VR applications, or social-networking applications. With social-networking applications, users may connect, communicate, and share information with other users in their social networks.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### SUMMARY OF PARTICULAR EMBODIMENTS

Reconstructed 3D maps (or 3D maps) of an environment provide users with 3D geometry information of physical objects in the real world, which can be used for (1) localizing users in the world (e.g., by comparing features detected in image captures to object features stored in the map, an AR device could determine the user's relative location within the map), and (2) supporting applications that need contextual information about the user's physical environment (e.g., generating AR effects relative to physical objects), etc. When users of artificial reality systems traverse throughout an environment, for example by moving throughout rooms or floors of a particular building, leaving the building and walking down a particular street, etc., artificial reality systems must provide synchronized, continuous, and updated feature maps with low latency in order to provide a high quality, immersive, and enjoyable experience for users. 3D maps can be stored locally (e.g., on the user's device) or through the cloud. Yet, the manner in which reconstructed 3D maps are indexed, updated, and provided to a user's device for large areas impacts device performance, and may lead to several technical problems such as map latency which degrade the user experience.

Particular embodiments disclose one or more distributed reconstructed 3D map networks (DMN) consisting of a central registry connected interpedently to one or more distributed worlds, where each world may represent a particular geographic space encompassed by a particular reconstructed 3D map as discussed above (e.g., the floor of a user's house, a particular street, a metro area, etc.). In particular embodiments, reconstructed 3D maps can be discovered and transmitted to one or more devices (e.g., an artificial reality system) via a network gateway. These embodiments permit users to quickly access reconstructed 3D maps as they enter or approach a particular area. By storing and transmitting the reconstructed 3D map for a particular area nearby the actual area (e.g., the reconstructed 3D map for a particular street may be stored on a hub or network junction point located on a lamp post on that street), users can quickly and seamlessly access the reconstructed 3D map for an area as they enter it, reducing the potential for latency and performance issues.

Further, the computing system can predict or determine the AR device is approaching a region not served by an accessed gateway, and request access to and download map data for a reconstructed 3D map for this region through, for example, a second gateway that services the region. In particular embodiments, this may require the device of the user to connect to the new gateway (e.g., the user moves from the streets, where the user's device is connected to a local hub that hosts public reconstructed 3D map, to their house, where they are connected to a unit layer hub that hosts private reconstructed 3D map). The computing system can utilize the reconstructed 3D map data to perform a variety of tasks to enhance the AR experience, for example localizing the AR device based on the reconstructed 3D map.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system and user.

FIG. 1B illustrates an example augmented reality system.

FIG. 2 illustrates a reconstructed 3D map that has been subdivided into one or more zones.

FIG. 3 illustrates an example architecture for a distributed reconstructed 3D map network (DMN).

FIG. 4 illustrates sample layered worlds of a distributed reconstructed 3D map network (DMN).

FIG. 5 illustrates the avatar of a user moving between reconstructed 3D maps.

FIG. 6 illustrates a sample method for localizing an AR device within a building using a 3D interior map.

FIG. 7 illustrates an example network environment associated with a social-networking system.

FIG. 8 illustrates an example computer system.

### DESCRIPTION OF EXAMPLE EMBODIMENTS

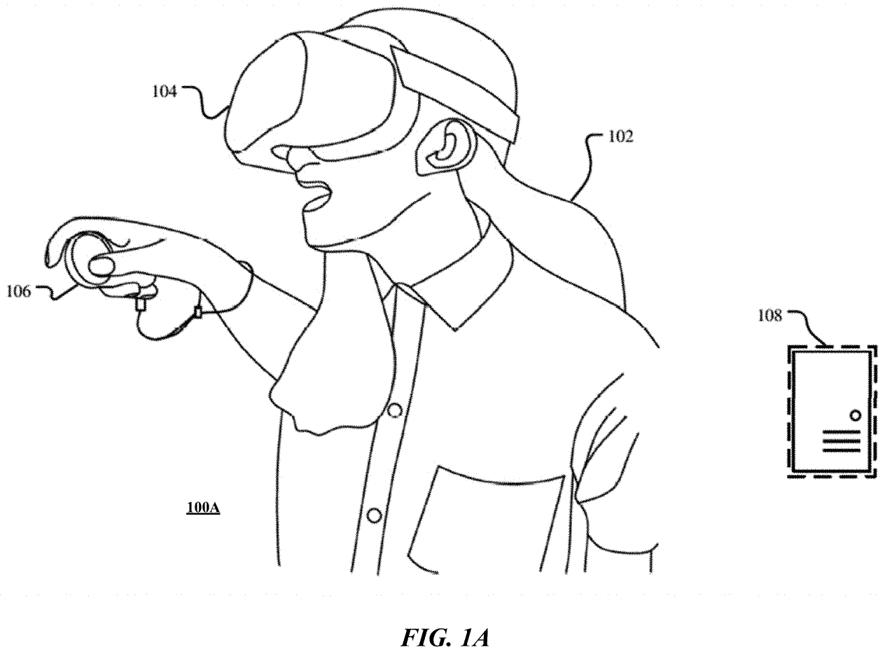

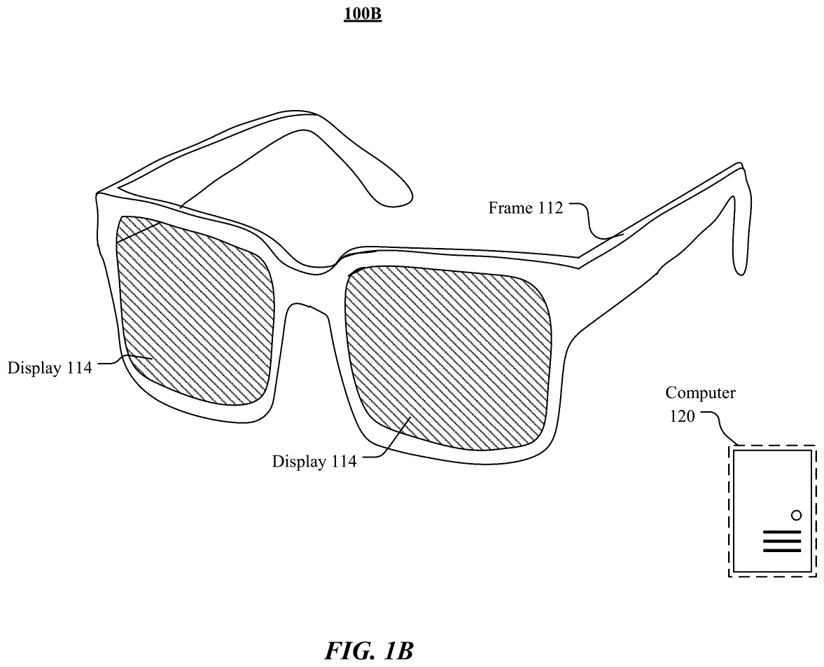

FIG. 1 illustrates an example artificial reality system 100 and user 102. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include an eye tracking system to determine a vergence distance of the user 102. A vergence distance may be a distance from the user's eyes to objects (e.g., real-world objects or virtual objects in a virtual space) upon which the user's eyes are converged. The headset 104 may be referred to as a head-mounted display (HMD). One or more controllers 106 may be paired with the artificial reality system 100. In particular embodiments, one or more controllers 106 may be equipped with at least one inertial measurement units (IMUs) and infrared (IR) light emitting diodes (LEDs) for the artificial reality system 100 to estimate a pose of the controller and/or to track a location of the controller, such that the user 102 may perform certain functions via the controller 106. In particular embodiments the one or more controllers 106 may be equipped with one or more trackable markers distributed to be tracked by the computing system 108. The one or more controllers 106 may comprise a trackpad and one or more buttons. The one or more controllers 106 may receive inputs from the user 102 and relay the inputs to the computing system 108. The one or more controllers 106 may also provide haptic feedback to the user 102. The computing system 108 may be connected to the headset 104 and the one or more controllers 106 through cables or wireless connections. The one or more controllers 106 may include a combination of hardware, software, and/or firmware not explicitly shown herein so as not to obscure other aspects of the disclosure.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

The reconstructed 3D map (or 3D map) of an environment provides users with 3D geometry information of physical objects in the real world, which can be used for (1) localizing users in the world (e.g., by comparing features detected in image captures to object features stored in the map, an AR device could determine the user's relative location within the map), (2) supporting applications that need contextual information about the user's physical environment (e.g., generating AR effects relative to physical objects), etc.

Users of artificial reality systems often wish to traverse and experience areas beyond a particular room or area, for example and not by way of limitation, moving throughout rooms or floors of a particular building, leaving the building and walking down a particular street, exploring a public space (e.g., a public park), or visiting another user's space (e.g., user B's living room). As the user moves throughout these spaces, artificial reality systems must provide synchronized, continuous, and updated feature maps with low latency in order to provide a high quality, immersive, and enjoyable experience for users. In particular embodiments systems provide, index, and update one or more reconstructed 3D maps that corresponds to the area the user is experiencing (e.g., a “interior 3D map” for a user's home, a “3D street map” for a particular street, or “public 3D map” for a particular public area). These maps can be stored locally (e.g., on the user's device) or through the cloud. Yet, the manner in which reconstructed 3D maps are indexed, updated, and provided to a user's device for large areas impacts device performance, and may lead to map latency which degrades the user experience.

For example, as the size of the area the user experiences increases, technical problems associated with the file size and corresponding storage requirements increase. As file sizes increases, a user's artificial reality system may be unable to locally store reconstructed 3D maps for the full space the user is experiencing. For example, available storage capacity in computing system 108 may be limited by its hardware (e.g., 64GB of storage), greatly limiting the size of the reconstructed 3D map that can be stored locally by user 102. Rather than transmit reconstructed 3D maps from a remote server, which adds latency due to its distance from the user, embodiments disclosed herein provide distributed reconstructed 3D map networks (DMNs) that store reconstructed 3D maps in a geographic hierarchy and permit users to access one or more reconstructed 3D maps of particular geographic areas as the user explores or approaches the corresponding geographic area. DMNs may further provide one or more reconstructed 3D maps, or one or more zones of a reconstructed 3D map (e.g., a reconstructed 3D map that corresponds to a particular geographic area such as a room, house, street, subdivision, city, etc.) to a user of an artificial reality system as needed. In particular embodiments reconstructed 3D maps that correspond to a particular geographic area may be stored at one or more nearby geographic locations in the DMN, and a user may discover and access a reconstructed 3D map for a particular area according to methods described herein.

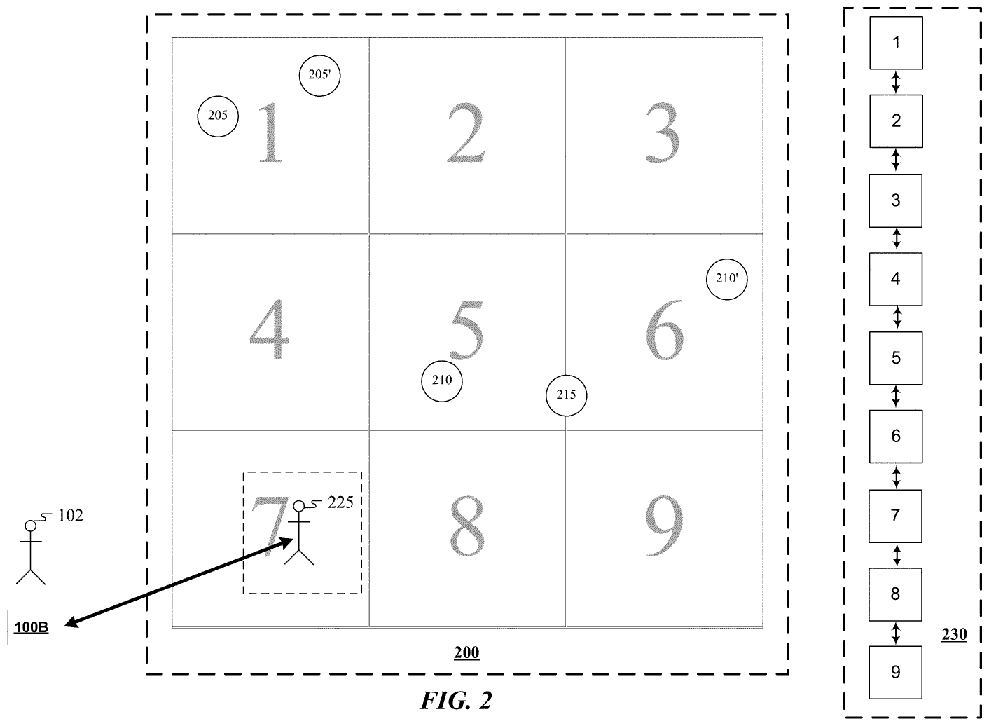

In particular embodiments a reconstructed 3D map may be subdivided into one or more zones for hosting, indexing, and updating. FIG. 2 illustrates a reconstructed 3D map 200 that has been subdivided into one or more zones. In particular embodiments, these zones may be based on one or more geometric properties of the area. For example, if a particular reconstructed 3D map 200 is a square area with 30 foot by 30 foot dimensions (e.g., the ground floor of the user's house), the reconstructed 3D map may be equally subdivided by area into nine square 10 foot by 10 foot zones. In particular embodiments, these zones may be based on the natural layout or particular subdivisions of the space encompassed by reconstructed 3D map 200. For example, if a particular reconstructed 3D map is a ground floor of a house, the reconstructed 3D map may be subdivided by room (e.g., a zone corresponding to the living room, kitchen, hallway, bathroom, etc.) or any particular number of divisions necessary to encompass the entire area of the reconstructed 3D map.

Reconstructed 3D map 200 may be defined in varying sizes depending on the geographic area of interest. While the examples in the previous paragraph considered a reconstructed 3D map of the ground floor of the user's house, in another example the reconstructed 3D map 200 may be an area defined by a city or neighborhood property boundary. In this example, the reconstructed 3D map 200 may be subdivided into zones based on one or more geometric properties (e.g., each zone may define a square measuring one city block by one city block), or reconstructed 3D map 200 may be subdivided into zones based on the natural layout or particular subdivisions of the space (e.g., each zone may be defined by a property boundary according to, for example, the city's ArcGIS database, or each zone may be defined by a geographic feature, for example and not by way of limitation, a lake or mountain range).

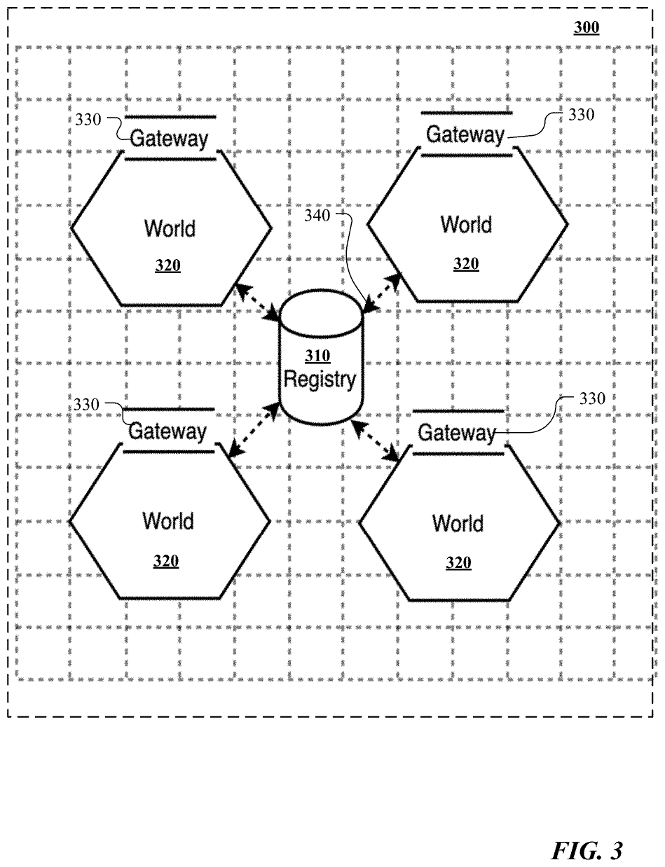

FIG. 3 illustrates an example architecture for a distributed reconstructed 3D map network (DMN). In particular embodiments, DMN 300 may consist of a central registry 310 connected interpedently to one or more distributed worlds 320, where each world may represent a particular geographic space encompassed by a particular reconstructed 3D map as discussed above (e.g., the floor of a user's house, a particular street, a metro area, etc.). In particular embodiments, the corresponding reconstructed 3D map for each world 320 be discovered and transmitted to one or more devices (e.g., an artificial reality system) via a network gateway 330. In some embodiments, the computing system may query the registry based on the location of the AR device. Such architecture permits for a linked system of reconstructed 3D maps, that although independently separated from one another, can be discovered and interconnected through central registry 310 and one or more gateways 330. Gateway 330 serves as the network discoverable end point of a reconstructed 3D map, may provide translation between private and public reconstructed 3D maps, and may be utilized for security and privacy control according to the methods described herein. The AR device may request access to a gateway 330 associated with DMN 300 to receive one or more reconstructed 3D maps or updates to reconstructed 3D maps that correspond to a particular area.

In particular embodiments, each reconstructed 3D map or object within DMN 300 may be registered and indexed within central registry 310. In particular embodiments each reconstructed 3D map can be registered according to three gateway addressing schemes: (1) physical, which use location codes to pin point and identify the exact location of the reconstructed 3D map in physical space; (2) logical, which uses reconstructed 3D map addresses to establish an interconnected relationship between a network of one or more reconstructed 3D maps within DMN 300; and (3) symbolic, which uses reconstructed 3D map names and may be utilized for human interaction. One or more of these addressing schemes and corresponding identifying information can be used by central registry 310 to index and address each reconstructed 3D map.

In particular embodiments, DMN 300 may use location codes in a physical addressing scheme. Location codes (e.g., “dr57utv+6f”) provide the most specific of the addressing schemes, as they require no additional contextual information for identification. In particular embodiments, location codes can encode a region in space with arbitrary precision. In particular embodiments, the location code may represent a 3D location (i.e., it includes a latitude, longitude, and elevation). In particular embodiments, the location codes may be either absolute (e.g., mapped to a global coordinate system) or relative (mapped to the position of one or more other reconstructed 3D maps).

In particular embodiments, DMN 300 may use reconstructed 3D map addresses in a logical addressing scheme. In particular embodiments reconstructed 3D map addresses (e.g., “192.168.4.32@@ 123e45”) may represent both an IP address to a live map gateway and an ID for an 3D object or relative location code in space.

In particular embodiments, DMN 300 may use reconstructed 3D map names in a symbolic addressing scheme. Reconstructed 3D map names may comprise name spaces of reconstructed 3D map addresses (e.g., “lmtp://stevehouse.kirkland.wa.us/teddybear”). In particular embodiments reconstructed 3D map addresses may be used to distinguish between private and public spaces, or provide organizational and geographical distinctions. In particular embodiments, the reconstructed 3D map names in a symbolic addressing may persist even as the physical or logical address changes for a particular reconstructed 3D map.

In particular embodiments, one or more devices or components of the DMN 300 may incorporate particular hardware and software to optimize and facilitate reconstructed 3D maps indexing and sharing. For example, a particular gateway 330 (e.g., a router or network hub) may incorporate or be associated with a system on a chip (“SOC”) or one or more separate processors that are assigned to particular zone of one or more reconstructed 3D maps. In particular embodiments, a reconstructed 3D map SOC may include, for example and not by way of limitation, machine learning interference capabilities, indexing accelerating, visual input/output (VIO) accelerating, dense reconstructions, or data aggregation capabilities. In particular embodiments one or more of these capabilities may be integrated directly into the SOC hardware. In particular embodiments, the SOC may utilize multiple power configurations, and operate at low-power requirements (e.g., 1-5 watts). In particular embodiments one or more separate processors may utilize a distributed shared memory (DSM) model to allow for smooth and continuous generation of 3D objects as a user moves throughout one or more zones of a reconstructed 3D map.

In particular embodiments, specific devices or components comprising the DMN 300 may be assigned to each reconstructed 3D map, or each zone of the reconstructed 3D map. For example, returning to FIG. 2, where reconstructed 3D map 200 comprises nine subdivided zones, a set of separate processors 230 within a gateway 330 may be assigned to each zone of the reconstructed 3D map (e.g., one processor manages zone 1 of reconstructed 3D map 200, another manages zone 2, etc.). Each separate processor will handle the updates and serve as the true source of reconstructed 3D map information for its corresponding zone. In particular embodiments, the separate processor assigned to each zone may be responsible for performing specific operations, for example and not by way of limitation indexing and updating the assigned zones as required. For example, if an object (e.g., a lamp) is moved from location 205 to location 205′ within the same zone (zone 1 as depicted in FIG. 2), the separate processor for zone 1 may perform appropriate operations to update zone 1 of reconstructed 3D map 200. As another example, if another object is moved from location 210 in zone 5 to location 210 in zone 6, or if an object is placed in location 215, such that it is located on a boundary that overlaps two zones (e.g., the boundary between zone 5 and zone 6), the separate processor assigned to zone 5 and the separate processor assigned to zone 6 may both perform appropriate operations to update zone 5 and zone 6 of reconstructed 3D map 200. In particular embodiments, both processors may utilize a distributed shared memory (DSM) model to reduce latency and ensure a smooth and continuous experience.

Links 340 may connect one on more components of DMN 300 to each other. This disclosure contemplates any suitable links 340. In particular embodiments, one or more links 340 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 340 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 340, or a combination of two or more such links 340. Links 340 need not necessarily be the same throughout DMN 300. One or more first links 340 may differ in one or more respects from one or more second links 340.

Another benefit of the DMNs disclosed herein arises from the need to rapidly transmit reconstructed 3D maps to the user's artificial reality system as the user enters and moves throughout new zones of the reconstructed 3D map (e.g., moves from their bedroom to their living room) or moves from one reconstructed 3D map to another (e.g., moves from their yard to a public park down the street, etc.). This is especially true as the size the of the geographic area the user is experiencing increases. Such changes create the potential for performance degradation, as this creates the potential for latency. Significant latency or other performance issues may discourage users from purchasing or interacting with applications that utilize reconstructed 3D maps. Embodiments disclosed herein utilize DMNs based on a geographic hierarchy that permit users to quickly access reconstructed 3D maps as they enter or approach a particular area. By storing and transmitting the reconstructed 3D map for a particular area nearby the actual area (e.g., the reconstructed 3D map for a particular street may be stored on a hub or network junction point located on a lamp post on that street), users can quickly and seamlessly access the reconstructed 3D map for an area as they enter it, reducing the potential for latency and performance issues.

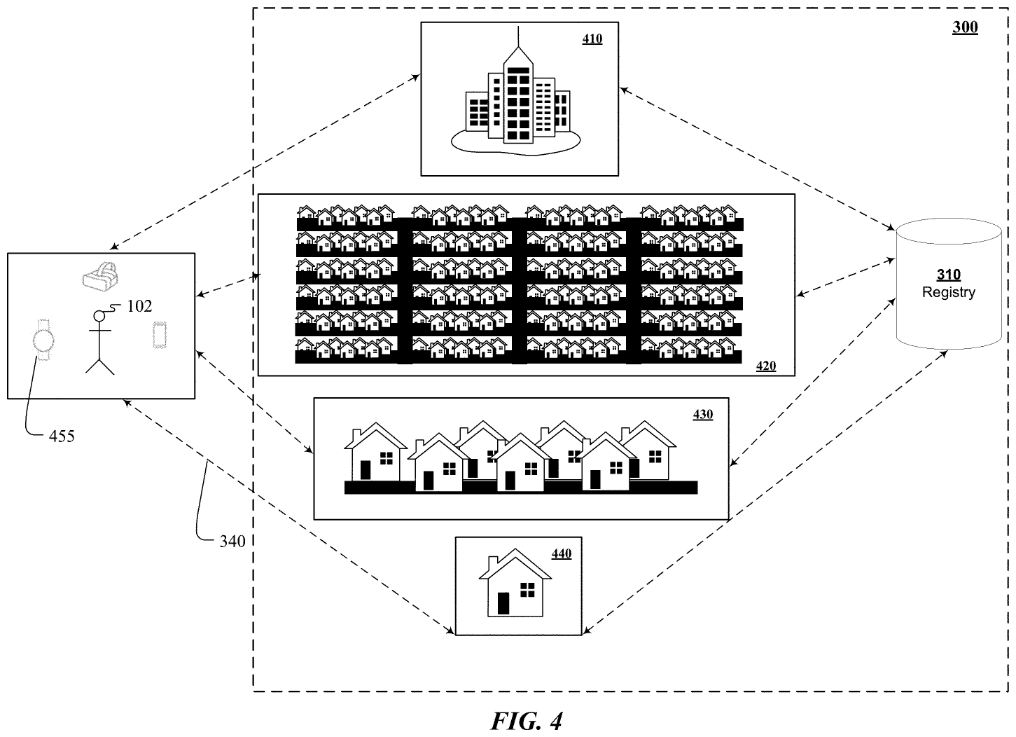

FIG. 4 illustrates sample layered worlds of a distributed reconstructed 3D map network (DMN). In particular embodiments, DMN 300 may comprise several layered worlds. As discussed previously, each layer within DMN 300 may be interconnected to one another through connections to central registry 310. Each layer within DMN 300 may comprise a gateway 330. In particular embodiments, each subsequent layer in the network may comprise hardware (e.g., a gateway 330) with decreasing power and storage capacities, permitting larger reconstructed 3D maps to be stored and shared with users at higher layers. In particular embodiments, the reconstructed 3D map stored at each layer will only expose high-level relational information (e.g., the geospatial relationship between reconstructed 3D maps) to each map layer above it. For example, when a user returns to their home, the computing system will initially localize the user's location using the broadest map (e.g., a city-level map) and then transition to smaller map areas as available (e.g., a map of the user's street, then a map of the user's apartment complex, followed by a map of the user's apartment unit). This architecture further permits the user to have full localization capabilities without exposing private data. For simplicity and readability, each layer comprising DMN 300 is described herein in order of decreasing size of the reconstructed 3D map area.

DMN may begin at a metro layer 410. Metro layer 410 can correspond to a particular region (e.g., a particular city or geographic region, for example the Seattle, WA metro region). In particular embodiments the reconstructed 3D map for metro layer 410 may be stored at a city data center at a local hub. In particular embodiments the local hub comprises hardware and software that provide a wide range of functionality for the particular region. For example and not by way of limitation, local hub can host and share public reconstructed 3D maps for the metro region (e.g., reconstructed 3D map data for public regions such as sidewalks, streets, parks, businesses, public transit routes that may be located in the particular region), provide networking capabilities (e.g., wireless LAN or a cellular network), and the ability to integrate with one or more devices that may provide updates to the hosted reconstructed 3D map (e.g., robotic vehicle mapping). In particular embodiments a metro hub may index and facilitate cloud backups of the public reconstructed 3D maps and corresponding data for the particular region encompassed by metro layer 410 (“Level 3 indexing”).

In particular embodiments metro layer 410 can encompass one or more neighborhood layers 420. Neighborhood layer 420 can correspond to a particular region (e.g., a particular subdivision, neighborhood or region comprising hundreds to thousands of homes) that is smaller than, and encompasses a region that is covered by metro layer 410. In particular embodiments, the reconstructed 3D map for the neighborhood layer 420 may be stored at a neighborhood safety center or village hall at a neighborhood hub. In particular embodiments the neighborhood hub comprises hardware and software that provide a wide range of functionality for the neighborhood layer region. For example and not by way of limitation, neighborhood hub can host and share public reconstructed 3D maps for the particular region covered by the neighborhood (i.e., reconstructed 3D map data for the neighborhood region that all users may access, e.g., reconstructed 3D map data for public regions such as sidewalks, streets, parks, public businesses that may be located in the particular region), provide networking capabilities (e.g., wireless LAN or a cellular network), and the ability to integrate with one or more devices that may provide updates to the hosted reconstructed 3D map (e.g., robotic vehicle mapping). In particular embodiments a neighborhood hub may index and facilitate cloud backups of the public reconstructed 3D maps and corresponding data for the particular region encompassed by neighborhood layer 420 (“Level 2 indexing”).

In particular embodiments the neighborhood layer 420 can encompass one or more local layers 430. Local layer 430 can correspond to a particular region (e.g., a particular street comprising 5-10 homes) that is smaller than and encompasses a region that is covered by neighborhood layer 420. In particular embodiments the reconstructed 3D map for the local layer 430 may be stored on a lamp post or other public utility at a local hub. In particular embodiments the local hub comprises hardware and software that provide a wide range of functionality for local layer 430. For example and not by way of limitation, the local hub can host and share public reconstructed 3D maps for the particular region covered by the local hub (i.e., reconstructed 3D map data for a particular region that all users may access, e.g., reconstructed 3D map data for public regions such as sidewalks, streets, and parks that may be located in the local layer 430), provide networking capabilities (e.g., wireless LAN or a cellular network), and the ability to integrate with one or more devices that may provide updates to the hosted reconstructed 3D map (e.g., robotic vehicle mapping). In particular embodiments the local hub may index and facilitate cloud backups of the public reconstructed 3D maps and corresponding data for the particular region encompassed by local layer 430 (“Level 1 indexing”).

In particular embodiments the local layer 430 can encompass one or more unit layers 440. Unit layer 440 can correspond to a particular region (e.g., a user's private residence) that is smaller than local layer 430. In particular embodiments the reconstructed 3D map for unit layer 440 may be stored locally within the router or wireless system for the unit at a unit hub. In particular embodiments the unit hub may comprise hardware and software that provides a wide-range of functionality for the unit layer 440. For example and not by way of limitation, the unit layer hub can host private reconstructed 3D maps (i.e., reconstructed 3D map data for a particular region that a user may wish to restrict or limit access to, e.g., reconstructed 3D map data for one or more rooms of the user's house), function as an internet-of-things (JOT) hub, host one or more smart appliances, provide networking capabilities (e.g., wireless LAN or a cellular network), and the ability to integrate with one or more devices that may provide updates to the hosted reconstructed 3D map (e.g., robotic vehicle mapping). Because the reconstructed 3D maps in unit layer 440 are stored locally (e.g., on the unit hub or server associated with the unit), the owner of the reconstructed 3D map can ensure privacy yet integrate this map with the remaining reconstructed 3D maps in DMN 300 through the gateway. In particular embodiments the unit hub may index and facilitate cloud backups of the private reconstructed 3D maps and corresponding data encompassed by unit layer 440 (“Level 0 indexing”).

Each layer of DMN 300 connect to one or more end user devices 455 for each user of DMN 300. One or more user devices 455 may include, for example and not by way of limitation, an artificial reality system, a mobile device, headphones, or a smartwatch. In particular embodiments one or more user devices 455 can connect to each layer. One or more user devices 455 may provide local storage of private reconstructed 3D maps that correspond to a particular region, for example, a user's room or house. One or more user devices 455 may further collect and provide captured sensor or image data that can be utilized to update one or more reconstructed 3D maps (e.g., image data comprising information that a particular object, such as a chair, has been relocated). In particular embodiments a user device 455 that corresponds to User A may directly communicate and share data (such as a reconstructed 3D map) with a user device 455 that corresponds to User B. Such direct sharing further provides a low power, low latency solution to sharing local reconstructed 3D maps.

In particular embodiments one or more reconstructed 3D maps may be made available to the AR device. For example, when a user of an AR device is about to physically enter an area encompassed by a particular reconstructed 3D map, the registry will provide a network-discoverable gateway address for the user to connect or request access to. As another example one or more relevant reconstructed 3D maps may be determined based on the particular gateway a user is interacting with (e.g., a neighborhood hub, a unit layer hub, etc.), or based on the one or more of the addressing schemes in the central registry. In particular embodiments the determination may be based on one or more requests from the user of the AR device to determine relevant reconstructed 3D maps, for example and not by way of limitation, a voice input (e.g., “Travel to 123 Main Street”, “Go to the Washington Monument”, or “Go to John's house”). In particular embodiments this determination may be based on one or more sensor data or image data from the AR device. For example, in particular embodiments the computing system may utilize the current location of the user to determine one or more relevant reconstructed 3D maps that correspond to the surrounding areas.

In particular embodiments the one or more relevant reconstructed 3D maps may be determined based on a region of interest around an avatar or AR device of the user. Returning to FIG. 2, region of interest 220 defines an area around an avatar 225 of user 102. In particular embodiments, region of interest 220 may be a two-dimensional shape (e.g., a square) or a three-dimensional volume (e.g., a cube). In particular embodiments, region of interest 220 may be a predetermined size and shape, for example and not by way of limitation, a cube of 1,000 cubic meters with a centroid located at the current location of the user. In particular embodiments, region of interest 220 may be dynamically adjusted based on the sensor data from the artificial reality system. For example, if the computing system determines the user is moving at a high velocity (e.g., running), the size of region of interest 220 may increase.

In particular embodiments, region of interest 220 may determine which reconstructed 3D maps user 102 is able to access, or which reconstructed 3D maps are updated for user 102. For example, as the avatar 225 of user 102 travels around an area, the computing system will be provided with one or more reconstructed 3D maps and corresponding reconstructed 3D map updates that encompass region of interest 220, or one or more zones of a reconstructed 3D map and corresponding zone updates that encompass region of interest 220. For example, as depicted in FIG. 2, when region of interest 220 corresponding to avatar 225 is located in zone 7, the corresponding zone 7 separate processor will provide reconstructed 3D map data to the computing system that encompasses the region of interest 220 surrounding user 102. When the region of interest 220 corresponding to avatar 225 crosses over to zone 8, the zone 8 separate processor will provide reconstructed 3D map data to the computing system that encompasses the region of interest 220 corresponding to avatar 225. If the region of interest 220 overlaps between two zones, the separate processor for each zone may simultaneously provide reconstructed 3D map data to the computing system that encompasses the region of interest 220 corresponding to avatar 225. In particular embodiments, both processors may utilize a DSM model to reduce latency and ensure a smooth and continuous experience. As previously described, each zone of the reconstructed 3D map each contains 3D object model information of objects within those zones. When something changes in each zone (e.g., an object is moved to a different location), that zone's assigned processor will handle reconstructed 3D map updates as described herein. In particular embodiments, the 3D object models in the updated reconstructed 3D maps will be utilized to place virtual objects around the user to recreate a complete 3D model for the region of interest 220 corresponding to avatar 225.

Additional considerations when providing updated reconstructed 3D maps to users concern privacy and access restrictions for particular reconstructed 3D maps, or particular regions of reconstructed 3D maps. While some reconstructed 3D maps hosted on DMN 300 may be in the public domain (e.g., a map of a public park), others may be privately owned (e.g., a map of a user's house). While privately owned reconstructed 3D maps are hosted on DMN 300, the owner of particular private reconstructed 3D map may wish to restrict or limit access to this reconstructed 3D map to specific users (e.g., their family members and invited guests), thus preventing uninvited users from virtually entering and exploring their home without permission. These privacy concerns may extend to particular rooms or zones of a private reconstructed 3D map. For example, a user may wish to grant reconstructed 3D map access that corresponds to the living room and kitchen areas of a user's home, but the not bedrooms. As another example, a bank may wish to provide public reconstructed 3D map access to its lobby and bank teller counter, but restrict or limit access to its employee offices, file room, and bank vault. Particular embodiments disclosed herein provide methods for facilitating access to one or more reconstructed 3D maps or one or more zones of a reconstructed 3D map registered and hosted on DMN 300. Further embodiments describe methods to facilitate the seamless transition between reconstructed 3D maps, or between one or more zones of a reconstructed 3D map as a user moves throughout the environment.

In particular embodiments the computing system may determine whether the user has permission to access the one or more relevant reconstructed 3D maps, or one or more zones of a reconstructed 3D map based on one or more criteria. For example, access permission may be based on authentication information, for example and not by way of limitation, a privacy setting of the reconstructed 3D map (e.g., whether the map is in the public domain or private), a previous or current connection of the user's device (e.g., whether the device is currently or has previously connected to gateway that hosts reconstructed 3D maps data), a credential provided to the user to gain access (e.g., the user receives an invitation to access the reconstructed 3D map, or requests access from the reconstructed 3D map owner or administrator), or based on a connection on a social networking service (e.g., the user shares a connection with the reconstructed 3D map owner or administrator on a social networking service). In particular embodiments, the computing system may provide one or more relevant reconstructed 3D maps and corresponding object data for download through the gateway.

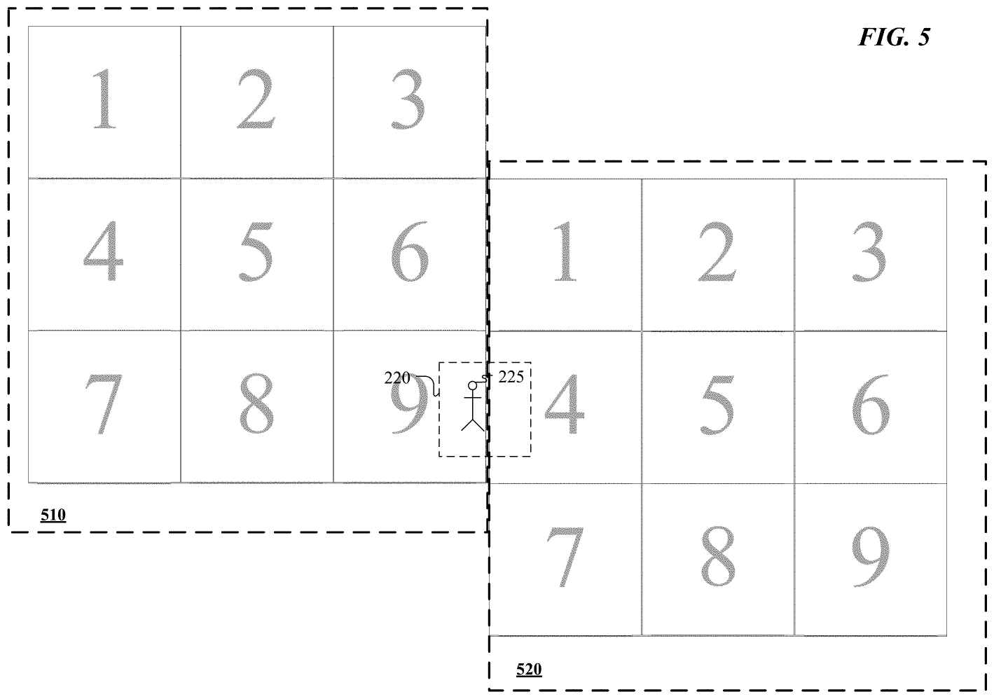

In particular embodiments, the user and corresponding region of interest 220 may move from an area that contains one reconstructed 3D map area to another, which may require accessing a different gateway. FIG. 5 illustrates the avatar 225 of a user moving between reconstructed 3D maps. The computing system may use information to predict that the user of the AR device is entering or about to enter an area where the current reconstructed 3D map lacks coverage, or an area no serviced by the current gateway. In particular embodiments, the computing system may make this prediction based on the location of region of interest 220 (e.g., whether the region of interest is approaching or intersects with the boundary of reconstructed 3D map 520). In other embodiments the computing system may utilize a bounding volume of the reconstructed 3D map to determine the user is approaching the boundary or a threshold distance from the boundary of reconstructed 3D map 520, for example a property boundary of the home. As another example, the computing system may make this prediction based on a previous or current network connection of the AR device to the second gateway that hosts the reconstructed 3D map for region 520, the current location of the AR device, a request by the user of the AR device to access the reconstrued 3D map for region 520; or a request to share the reconstructed 3D map for region 520 from an owner of the map.

In particular embodiments based on a prediction or determination that the user of the AR device is entering or approaching a region that is not served by the accessed gateway, the system may localize the user relative the one or more relevant accessible reconstructed 3D maps and aggregate object data. In particular embodiments, the 3D object models in the reconstructed 3D maps will be utilized to, for example and not by way of limitation, place virtual objects around the user to recreate a complete 3D model for the region of interest 220 corresponding to avatar 225. In particular embodiments the computing system may continuously receive updates to the one or more relevant accessible reconstructed 3D maps and corresponding object data hosted through the gateway. Using these updates, the computing system may relocalize the user and relocate objects as required in the space, including when one or more reconstructed 3D maps for a particular area the user is entering are downloaded.

Further, based on a prediction or determination the user of the AR device is approaching a region not served by the accessed gateway, (e.g., the user approaches the boundary or crosses from reconstructed 3D map 510 to reconstructed 3D map 520), the computing system request to access and download map data for reconstructed 3D map 520 through, for example, a second gateway that services area 520. For example, if the area covering reconstrued 3D map 510, of the streets, is in the public domain, whereas the area covering reconstructed 3D map 520, of the user's house, is privately owned, the computing system will determine if reconstructed map 520 is accessible to the user using the methods described herein. In particular embodiments, this may require the device of the user to connect to the new gateway (e.g., the user moves from the streets, where the user's device is connected to a local hub that hosts public reconstructed 3D map 510, to their house, where they are connected to a unit layer hub that hosts private reconstructed 3D map 520). If required, the registry may notify the device regarding which gateway to connect to. As the user crosses the threshold between reconstructed 3D maps, the new gateway will provide reconstructed 3D maps and object models that correspond to objects within the region of interest 220 in the user's house on reconstructed 3D map 520. Additionally, in particular embodiments the old gateway (e.g., the one servicing area reconstructed 3D map area 510) will continue to provide 3D object models that correspond to objects within the region of interest 220 on the streets on reconstructed 3D map 510. Those 3D object models from both reconstructed 3D maps will simultaneously be positioned and updated around the user 102 within region of interest 220. Thus, even though the user is crossing between reconstructed 3D maps hosted by different physical entities, the reconstructed 3D map observed by the user within the region of interest 220 would remain smooth and continuous as the user moves throughout their environment.

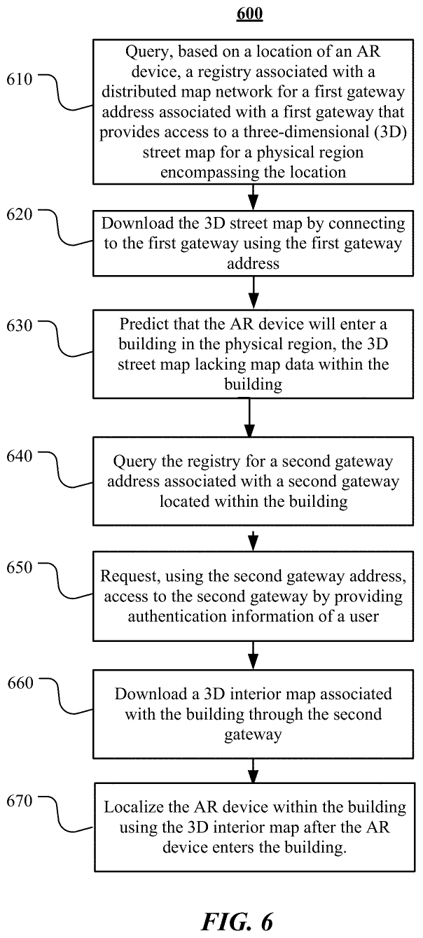

FIG. 6 illustrates a sample method 600 for localizing an AR device within a building using a 3D interior map.

The method may begin at step 610, where a computing system queries, based on a location of an AR device, a registry associated with a distributed map network for a first gateway address associated with a first gateway that provides access to a three-dimensional (3D) street map for a physical region encompassing the location. The registry may be connected interpedently to one or more distributed worlds, where each world may represent a particular geographic space. In particular embodiments the 3D street map may be registered and indexed within the registry. In particular embodiments the 3D street map can be registered according to a gateway addressing scheme. In particular embodiments the gateway may incorporate a system on a chip (“SOC”) or one or more separate processors that are assigned to particular zone of one or more 3D street maps.

At step 620, the computing system downloads the 3D street map by connecting to the first gateway using the first gateway address.

At step 630, the computing system predicts that the AR device will enter a building in the physical region, the 3D street map lacking map data within the building. In particular embodiments, the computing system may make this determination based on the location of a region of interest (e.g., whether the region of interest is approaching or intersects with the boundary of the interior 3D map). In other embodiments the computing system may utilize a bounding volume of the interior 3D map to determine the AR device is approaching the boundary of interior 3D map, for example a property boundary of the home or private residence.

At step 640, the computing system queries the registry for a second gateway address associated with a second gateway located within the building. At step 650, the computing system requests, using the second gateway address, access to the second gateway by providing authentication information of a user. The authentication information may be a privacy setting of the interior 3D map (e.g., whether the map is in the public domain or private), a previous or current connection of the user's device (e.g., whether the device is currently or has previously connected to second gateway), a credential provided to gain access (e.g., the user receives an invitation to access the interior 3D map, or requests access from the interior 3D map owner or administrator), or based on a connection on a social networking service (e.g., the user shares a connection with the interior 3D map owner or administrator on a social networking service).

At step 660, the computing system downloads a 3D interior map associated with the building through the second gateway. In particular embodiments the 3D interior map may be subdivided into zones based on one or more geometric properties (e.g., each zone may define a room of the building). In particular embodiments the 3D interior map may be registered and indexed within the registry. In particular embodiments the 3D interior map can be registered according to a gateway addressing scheme. In particular embodiments the gateway may incorporate a system on a chip (“SOC”) or one or more separate processors that are assigned to particular zone of one or more 3D interior maps.

At step 670, the computing system localizes the AR device within the building using the 3D interior map after the AR device enters the building. The computing system may initially localize the user's location using the broadest map (e.g., the 3D street map) and then transition to smaller map areas as available (e.g., the 3D interior map).

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for localizing an AR device within a building using a 3D interior map including the particular steps of the method of FIG. 6, this disclosure contemplates any suitable method for localizing an AR device within a building using a 3D interior map including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

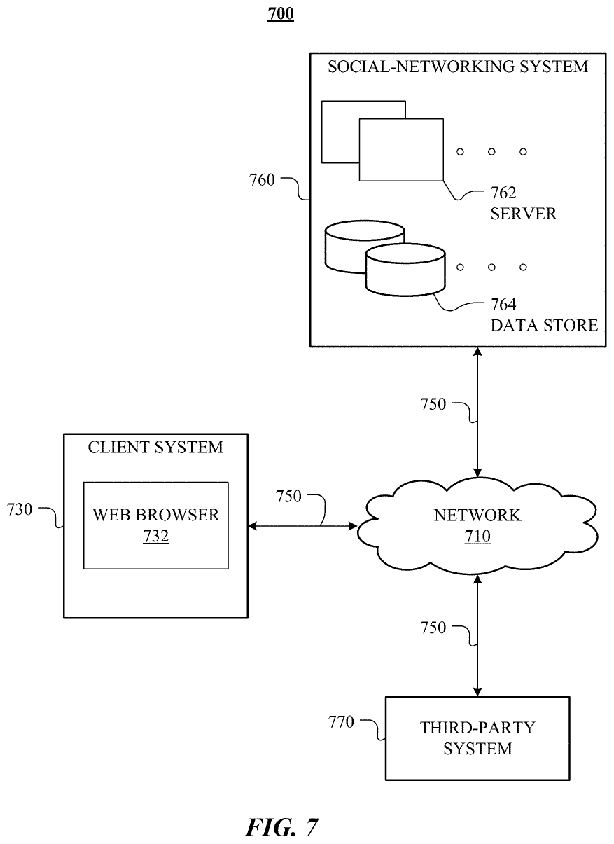

FIG. 7 illustrates an example network environment 700 associated with a social-networking system. Network environment 700 includes a client system 730, a social-networking system 760, and a third-party system 770 connected to each other by a network 710. Although FIG. 7 illustrates a particular arrangement of client system 730, social-networking system 760, third-party system 770, and network 710, this disclosure contemplates any suitable arrangement of client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of client systems 730, social-networking systems 760, third-party systems 770, and networks 710, this disclosure contemplates any suitable number of client systems 730, social-networking systems 760, third-party systems 770, and networks 710. As an example and not by way of limitation, network environment 700 may include multiple client system 730, social-networking systems 760, third-party systems 770, and networks 710.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

In particular embodiments, client system 730 may be an electronic device including hardware, software, or embedded logic components or a combination of two or more such components and capable of carrying out the appropriate functionalities implemented or supported by client system 730. As an example and not by way of limitation, a client system 730 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 730. A client system 730 may enable a network user at client system 730 to access network 710. A client system 730 may enable its user to communicate with other users at other client systems 730.

In particular embodiments, client system 730 may include a web browser 732, and may have one or more add-ons, plug-ins, or other extensions. A user at client system 730 may enter a Uniform Resource Locator (URL) or other address directing the web browser 732 to a particular server (such as server 762, or a server associated with a third-party system 770), and the web browser 732 may generate a Hyper Text Transfer Protocol (HTTP) request and communicate the HTTP request to server. The server may accept the HTTP request and communicate to client system 730 one or more Hyper Text Markup Language (HTML) files responsive to the HTTP request. Client system 730 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 760 may be a network-addressable computing system that can host an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. As an example and not by way of limitation, client system 730 may access social-networking system 760 using a web browser 732, or a native application associated with social-networking system 760 (e.g., a mobile social-networking application, a messaging application, another suitable application, or any combination thereof) either directly or via network 710. In particular embodiments, social-networking system 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, social-networking system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, a social-networking system 760, or a third-party system 770 to manage, retrieve, modify, add, or delete, the information stored in data store 764.

In particular embodiments, social-networking system 760 may store one or more social graphs in one or more data stores 764. In particular embodiments, a social graph may include multiple nodes—which may include multiple user nodes (each corresponding to a particular user) or multiple concept nodes (each corresponding to a particular concept)—and multiple edges connecting the nodes. Social-networking system 760 may provide users of the online social network the ability to communicate and interact with other users. In particular embodiments, users may join the online social network via social-networking system 760 and then add connections (e.g., relationships) to a number of other users of social-networking system 760 to whom they want to be connected. Herein, the term “friend” may refer to any other user of social-networking system 760 with whom a user has formed a connection, association, or relationship via social-networking system 760.

In particular embodiments, social-networking system 760 may provide users with the ability to take actions on various types of items or objects, supported by social-networking system 760. As an example and not by way of limitation, the items and objects may include groups or social networks to which users of social-networking system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 760 or by an external system of third-party system 770, which is separate from social-networking system 760 and coupled to social-networking system 760 via a network 710.

In particular embodiments, social-networking system 760 may be capable of linking a variety of entities. As an example and not by way of limitation, social-networking system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating social-networking system 760. In particular embodiments, however, social-networking system 760 and third-party systems 770 may operate in conjunction with each other to provide social-networking services to users of social-networking system 760 or third-party systems 770. In this sense, social-networking system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 760 also includes user-generated content objects, which may enhance a user's interactions with social-networking system 760. User-generated content may include anything a user can add, upload, send, or “post” to social-networking system 760. As an example and not by way of limitation, a user communicates posts to social-networking system 760 from a client system 730. Posts may include data such as status updates or other textual data, location information, photos, videos, links, music or other similar data or media. Content may also be added to social-networking system 760 by a third-party through a “communication channel,” such as a newsfeed or stream.

In particular embodiments, social-networking system 760 may include a variety of servers, sub-systems, programs, modules, logs, and data stores. In particular embodiments, social-networking system 760 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 760 may also include suitable components such as network interfaces, security mechanisms, load balancers, failover servers, management-and-network-operations consoles, other suitable components, or any suitable combination thereof. In particular embodiments, social-networking system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 760 to one or more client systems 730 or one or more third-party system 770 via network 710. The web server may include a mail server or other messaging functionality for receiving and routing messages between social-networking system 760 and one or more client systems 730. An API-request server may allow a third-party system 770 to access information from social-networking system 760 by calling one or more APIs. An action logger may be used to receive communications from a web server about a user's actions on or off social-networking system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from client system 730 responsive to a request received from client system 730. Authorization servers may be used to enforce one or more privacy settings of the users of social-networking system 760. A privacy setting of a user determines how particular information associated with a user can be shared. The authorization server may allow users to opt in to or opt out of having their actions logged by social-networking system 760 or shared with other systems (e.g., third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

In particular embodiments, one or more objects (e.g., content or other types of objects) of a computing system may be associated with one or more privacy settings. The one or more objects may be stored on or otherwise associated with any suitable computing system or application, such as, for example, a social networking system 760, a client system 730, a third-party system 770, a social-networking application, a messaging application, a photo-sharing application, a virtual reality (VR) or augmented reality (AR) application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information. As another example and not by way of limitation, the social networking system 760 may store privacy policies/guidelines. The privacy policies/guidelines may specify what information of users may be accessible by which entities (e.g., users or third-party systems 770) and/or by which processes (e.g., internal research, advertising algorithms, machine-learning algorithms), thus ensuring only certain information of the user may be accessed by certain entities or processes.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node 204 corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social networking system 760 or shared with other systems (e.g., a third-party system 770). Although this disclosure describes using particular privacy settings in a particular manner, this disclosure contemplates using any suitable privacy settings in any suitable manner.

In particular embodiments, privacy settings may be based on one or more nodes or edges of a social graph 200. A privacy setting may be specified for one or more edges 206 or edge-types of the social graph 200, or with respect to one or more nodes 202, 204 or node-types of the social graph 200. The privacy settings applied to a particular edge 206 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social networking system 760. The object may be associated with a concept node 204 connected to a user node 202 of the first user by an edge 206. The first user may specify privacy settings that apply to a particular edge 206 connecting to the concept node 204 of the object, or may specify privacy settings that apply to all edges 206 connecting to the concept node 204. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social networking system 760 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social networking system 760 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 770, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 762 may be authorization/privacy servers for enforcing privacy settings. In response to a request from a user (or other entity) for a particular object stored in a data store 764, the social networking system 760 may send a request to the data store 764 for the object. The request may identify the user associated with the request and the object may be sent only to the user (or a client system 730 of the user) if the authorization server determines that the user is authorized to access the object based on the privacy settings associated with the object. If the requesting user is not authorized to access the object, the authorization server may prevent the requested object from being retrieved from the data store 764 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social networking system 760, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. As another example and not by way of limitation, the social networking system 760 may have privacy policies/guidelines that specify profile picture updates by users are public, but user search history is private and not accessible by any entities. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures. As another example and not by way of limitation, the social networking system 760 may have privacy policies/guidelines that specify that posts by users are only visible to friends of the user by default, but may also allow users to make their posts publicly viewable.

In particular embodiments, the social networking system 760 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social networking system 760 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social networking system 760 may access such information in order to provide a particular function or service to the first user, without the social networking system 760 having access to that information for any other purposes. Before accessing, storing, or using such objects or information, the social networking system 760 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social networking system 760.

In particular embodiments, a user may specify whether particular types of objects or information associated with the first user may be accessed, stored, or used by the social networking system 760. As an example and not by way of limitation, the first user may specify that images sent by the first user through the social networking system 760 may not be stored by the social networking system 760. As another example and not by way of limitation, a first user may specify that messages sent from the first user to a particular second user may not be stored by the social networking system 760. As yet another example and not by way of limitation, a first user may specify that all objects sent via a particular application may be saved by the social networking system 760.

In particular embodiments, privacy settings may allow a first user to specify whether particular objects or information associated with the first user may be accessed from particular client systems 730 or third-party systems 770. In particular embodiments, the social networking system 760 may store particular privacy policies/guidelines in the privacy settings. The particular privacy policies/guidelines may specify whether particular objects or information associated with the first user may be accessed from particular client systems 730 or third-party systems 770. The privacy settings may allow the first user to opt in or opt out of having objects or information accessed from a particular device (e.g., the phone book on a user's smart phone), from a particular application (e.g., a messaging app), or from a particular system (e.g., an email server). The social networking system 760 may provide default privacy settings with respect to each device, system, or application, and/or the first user may be prompted to specify a particular privacy setting for each context. As an example and not by way of limitation, the first user may utilize a location-services feature of the social networking system 760 to provide recommendations for restaurants or other places in proximity to the user. The first user's default privacy settings may specify that the social networking system 760 may use location information provided from a client device 730 of the first user to provide the location-based services, but that the social networking system 760 may not store the location information of the first user or provide it to any third-party system 770. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user. In particular embodiments, the social networking system 760 may store particular privacy policies/guidelines in the privacy settings associated with a user. The particular privacy policies/guidelines may specify one or more geographic locations from which objects can be accessed. As an example and not by way of limitation, a user may share an object and the particular privacy policies/guidelines may specify that only users in the same city may access or view the object. In particular embodiments, the social networking system 760 may update the privacy policies/guidelines adaptively based on one or more machine-learning algorithms. Continuing with the previous example, the social networking system 760 may analyze all the objects the user shared in a recent period based on machine-learning algorithms and update the policies/guidelines. The updated privacy policies/guidelines may specify that only users in the same country may access or view the object.

In particular embodiments, the social networking system 760 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social networking system 760. The user's privacy settings may specify that such information may be used only for particular processes, such as authentication, and further specify that such information may not be shared with any third-party system 770 or used for other processes or applications associated with the social networking system 760. As another example and not by way of limitation, the social networking system 760 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 770 or used by other processes or applications associated with the social networking system 760. As another example and not by way of limitation, the social networking system 760 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any third-party system 770 or used by other processes or applications associated with the social networking system 760.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social networking system 760 may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social networking system 760 may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social networking system 760 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social networking system 760 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social networking system 760 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social networking system 760 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social networking system 760 may send a reminder to the user to confirm his or her privacy settings every six months or after every ten photo posts. In particular embodiments, privacy settings may also allow users to control access to the objects or information on a per-request basis. As an example and not by way of limitation, the social networking system 760 may notify the user whenever a third-party system 770 attempts to access information associated with the user, and require the user to provide verification that access should be allowed before proceeding.

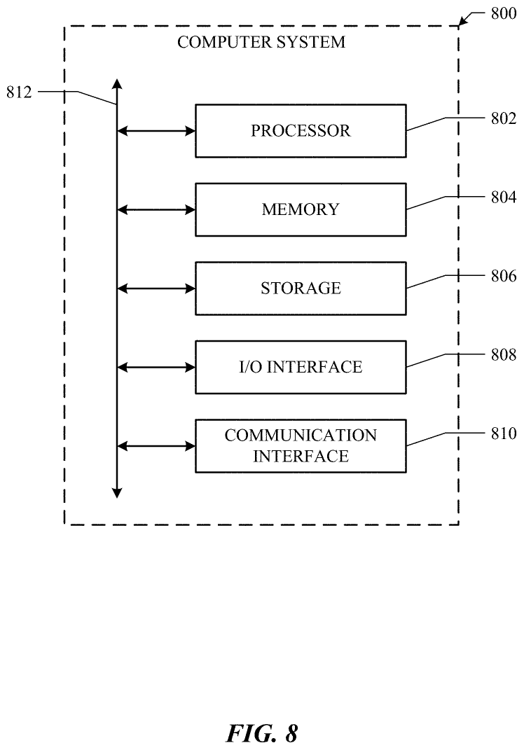

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system associated with an artificial reality (AR) device:
querying, based on a location of the AR device, a registry associated with a distributed map network for a first gateway address associated with a first gateway that provides access to a three-dimensional (3D) street map for a physical region encompassing the location;
downloading the 3D street map by connecting to the first gateway using the first gateway address;
predicting that the AR device will enter a building in the physical region, the 3D street map lacking map data within the building;
querying the registry for a second gateway address associated with a second gateway located within the building;
requesting, using the second gateway address, access to the second gateway by providing authentication information of a user;
downloading a 3D interior map associated with the building through the second gateway; and
localizing the AR device within the building using the 3D interior map after the AR device enters the building.

2. The method of claim 1, wherein the 3D interior map is stored locally on a computing system associated with the building.

3. The method of claim 1, wherein the 3D interior map is divided into one or more zones, wherein each zone comprises a room of the building.

4. The method of claim 3, wherein the second gateway is associated with one or more processors, wherein each of the one or more processors is assigned to a corresponding zone of the one or more zones.

5. The method of claim 1, wherein the authentication information comprises one or more of:
a previous or current network connection of the AR device to the second gateway;
a credential to access the 3D interior map; or
a connection of the user of the AR device with an owner of the 3D interior map on a social networking service.

6. The method of claim 1, wherein predicting the AR device will enter a building comprises:
generating a bounding volume around a perimeter of the building;
determining the location of the AR device is within a threshold distance from the bounding volume.

7. The method of claim 1, wherein predicting the AR device will enter a building is based on:
a previous or current network connection of the AR device to the second gateway;
the location of the AR device;
a request by the user to access the 3D interior map; or
a request to share the 3D interior map from an owner of the 3D interior map.

8. The method of claim 1, wherein the physical region comprises a metro area, a neighborhood, or a street.

9. The method of claim 1, wherein the building is a private residence.

10. One or more computer-readable non-transitory storage media including instructions that, when executed by one or more processors of a computing system, are configured to cause the one or more processors to perform operations comprising:
querying, based on a location of the AR device, a registry associated with a distributed map network for a first gateway address associated with a first gateway that provides access to a three-dimensional (3D) street map for a physical region encompassing the location;
downloading the 3D street map by connecting to the first gateway using the first gateway address;
predicting that the AR device will enter a building in the physical region, the 3D street map lacking map data within the building;
querying the registry for a second gateway address associated with a second gateway located within the building;
requesting, using the second gateway address, access to the second gateway by providing authentication information of a user;
downloading a 3D interior map associated with the building through the second gateway; and
localizing the AR device within the building using the 3D interior map after the AR device enters the building.

11. The media of claim 10, wherein the 3D interior map is stored locally on a computing system associated with the building.

12. The media of claim 10, wherein the 3D interior map is divided into one or more zones, wherein each zone comprises a room of the building.

13. The media of claim 12, wherein the second gateway is associated with one or more processors, wherein each of the one or more processors is assigned to a corresponding zone of the one or more zones.

14. The media of claim 10, wherein the authentication information comprises one or more of:
a previous or current network connection of the AR device to the second gateway;
a credential to access the 3D interior map; or
a connection of the user of the AR device with an owner of the 3D interior map on a social networking service.

15. The media of claim 10, wherein the instructions are further configured to cause the one or more processors to perform operations further comprising:
generating a bounding volume around a perimeter of the building;
determining the location of the AR device is within a threshold distance from the bounding volume.

16. A system comprising:
one or more processors; and
one or more computer-readable non-transitory storage media in communication with the one or more processors and comprising instructions, that when executed by the one or more processors, are configured to cause the system to perform operations comprising:
querying, based on a location of the AR device, a registry associated with a distributed map network for a first gateway address associated with a first gateway that provides access to a three-dimensional (3D) street map for a physical region encompassing the location;
downloading the 3D street map by connecting to the first gateway using the first gateway address;
predicting that the AR device will enter a building in the physical region, the 3D street map lacking map data within the building;
querying the registry for a second gateway address associated with a second gateway located within the building;
requesting, using the second gateway address, access to the second gateway by providing authentication information of a user;
downloading a 3D interior map associated with the building through the second gateway; and
localizing the AR device within the building using the 3D interior map after the AR device enters the building.

17. The system of claim 16, wherein the 3D interior map is stored locally on a computing system associated with the building.

18. The system of claim 16, wherein the 3D interior map is divided into one or more zones, wherein each zone comprises a room of the building.

19. The system of claim 18, wherein the second gateway is associated with one or more processors, wherein each of the one or more processors is assigned to a corresponding zone of the one or more zones.

20. The system of claim 16, wherein the authentication information comprises one or more of:
a previous or current network connection of the AR device to the second gateway;
a credential to access the 3D interior map; or
a connection of the user of the AR device with an owner of the 3D interior map on a social networking service.
